(19) United States
(12) Patent Application Publication
(10) Pub. No.: US 2026/0132747 A1
(43) Pub. Date: May 14, 2026

(54) GAS TURBINE ENGINE

(71) Applicant: GENERAL ELECTRIC COMPANY, Evendale, OH (US)

(72) Inventors: Miles Burnett, Cincinnati, OH (US); Sibtosh Pal, Mason, OH (US); Michael T. Bucaro, Arvada, CO (US); Chris K. Gannon, Cincinnati, OH (US)

(21) Appl. No.: 18/947,195

(22) Filed: Nov. 14, 2024

(51) Int. Cl. F02C 9/28; F02C 3/00; F23R 3/00

(52) U.S. Cl. CPC F02C 9/28; F02C 3/00; F23R 3/002; F05D 2240/35

(57) ABSTRACT

A gas turbine includes a compressor section, a combustion section, and a turbine section. The combustion section includes a combustor liner at least partially defining a plurality of combustor cups including a first set of combustor cups and a second set of combustor cups. A first fuel circuit includes a first manifold fluidly coupled with a fuel source and the first set of combustor cups. A second fuel circuit includes a second manifold fluidly coupled to the second set of combustor cups. A controller is configured to detect an engine condition, and to control the first fuel circuit and the second fuel circuit to selectively provide fuel from the fuel source to at least one of the first set of combustor cups or the second set of combustor cups according to the engine condition to facilitate lightoff or relighting of the combustion section.

### TECHNICAL FIELD

The present subject matter relates generally to a gas turbine engine having a combustion section.

### BACKGROUND

Turbine engines are driven by a flow of combustion gases passing through the engine to rotate a multitude of turbine blades, which, in turn, rotate a compressor to provide compressed air to the combustor for combustion. A combustor can be provided within the turbine engine and is fluidly coupled with a turbine into which the combusted gases flow.

Historically, hydrocarbon fuels are used in the combustor of a turbine engine. Generally, air and fuel are fed to a combustion chamber, the air and fuel are mixed, and then the fuel is burned in the presence of the air to produce hot gas. The hot gas is then fed to a turbine where it cools and expands to produce power. By-products of the fuel combustion typically include environmentally unwanted byproducts, such as nitrogen oxide and nitrogen dioxide (collectively called NOx), carbon monoxide (CO), unburned hydrocarbons (UHC) (e.g., methane and volatile organic compounds that contribute to the formation of atmospheric ozone), and other oxides, including oxides of sulfur (e.g., SO₂ and SO₃).

To reduce the environmentally unwanted byproducts, other fuels, such as hydrogen, are being explored. Hydrogen or hydrogen mixed with another element has a higher flame temperature than traditional hydrocarbon fuels. That is, hydrogen or a hydrogen mixed fuel typically has a wider flammable range and a faster burning velocity than traditional hydrocarbon-based fuels.

### BRIEF DESCRIPTION OF THE DRAWINGS

In the drawings:

FIG. 1 is a schematic view of a gas turbine engine having a compression section, a combustion section, and a turbine section in accordance with various aspects described herein.

FIG. 2 is a schematic view of the combustion section of FIG. 1 along line II-II in accordance with various aspects described herein.

FIG. 3 is an exemplary schematic view of a variation of the combustion section of FIG. 1 along line II-II in accordance with various aspects described herein.

FIG. 4 is another exemplary schematic view another variation of the combustion section of FIG. 1 along line II-II in accordance with various aspects described herein.

FIG. 5 is a flowchart diagram illustrating a method of operating a gas turbine according to various aspects of the disclosure.

### DETAILED DESCRIPTION

Aspects of the disclosure described herein are directed to a combustor for a gas turbine engine. Liquid hydrocarbon fuels, such as Jet-A, are atomized and vaporized prior to combustion. Gaseous hydrogen does not require atomization and vaporization for combustion. These factors contribute to the higher relative combustion efficiency for hydrogen when compared to liquid hydrocarbon fuels at sub-idle conditions like lightoff and relight. When utilizing hydrogen fuel for gas turbine engines for aircraft, it can be desirable to smooth the transition from lightoff or relight to an idle condition. For example, traditional fuels, such as Jet-A, can provide lower combustion efficiencies associated with lower fluid pressures at lightoff and relight, which can maintain combustor energy below a compressor stall threshold. In contrast, hydrogen fuel can provide relatively higher combustion efficiencies, even with lower fluid pressures at lightoff and relight, which can increase combustor energy above the compressor stall threshold. Introducing a flow of fuel in stages can prevent compressor stall during operation, such as during the transition from lightoff and relight to idle.

The disclosed combustion sections or fuel manifold strategies can include a plurality of independent fuel circuits, which can allow for fuel (e.g., hydrogen fuel) to be supplied to the combustor cups in stages. Supplying the hydrogen fuel in stages can allow for the turbine engine to more smoothly transition from a lightoff and relight condition to an idle state, while preventing compressor stall. Additionally, the independent fuel circuits can allow for the fuel flow to each combustor cup to be above lightoff and blowout thresholds, which may not be feasible with a single fuel circuit while limiting compressor stall. Furthermore, these manifold strategies (a) reduce risk of unburned hydrogen propagating downstream of the combustor prior to lightoff, and (b) alleviate control issues that may arise at low fuel flow rates utilized for lightoff, which can be difficult to achieve across the full engine operability range with a single circuit.

For purposes of illustration, the present disclosure will be described with respect to a gas turbine engine. It will be understood, however, that aspects of the disclosure described herein are not so limited. A combustor as described herein can be implemented in various engines, including but not limited to turbojet, turboprop, turboshaft, and turbofan engines. Aspects of the disclosure discussed herein may have general applicability within non-aircraft engines having a combustor, such as other mobile applications and non-mobile industrial, commercial, and residential applications.

With the combustors described herein, hydrogen fuel can be used without the need for diluents. In some embodiments, no diluent is added to the combustion chamber and the fuel is substantially completely diatomic hydrogen without diluent. As used herein, the term “substantially completely,” as used to describe the amount of a particular element or molecule (e.g., diatomic hydrogen), refers to at least 99% by mass of the described portion of the element or molecule, such as at least 97.5%, such as at least 95%, such as at least 92.5%, such as at least 90%, such as at least 85%, or such as at least 75% by mass of the described portion of the element or molecule. In some examples, the fuel is entirely (e.g., 100%) hydrogen by mass.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, “third”, etc. may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine exhaust.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

The term “fluid” may be a gas or a liquid. The term “fluidly coupled” means that a fluid is capable of making the connection between the areas specified.

The term “nozzle” has been used in various ways in the context of gas turbine engines. In the instant application, “nozzle” refers to a component having a portion for fluid coupling to a fuel supply and having at least one portion for fluidly coupling with a combustor cup, a combustor liner, a combustion chamber, or combinations thereof.

Additionally, as used herein, the terms “radial” or “radially” refer to a direction away from a common center. For example, in the overall context of a turbine engine, radial refers to a direction along a ray extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only the dimensions, positions, order, and relative sizes reflected in the drawings attached hereto can vary.

The singular forms “a”, “an”, and “the” include plural references unless the context clearly dictates otherwise. Furthermore, as used herein, the term “set” or a “set” of elements can be any number of elements, including only one.

Uses of “and” and “or” are to be construed broadly. For example and without limitation, uses of “and” do not necessarily require all elements or features listed, and uses of “or” are inclusive unless such a construction would be illogical.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, “generally”, and “substantially”, are not to be limited to the precise value specified. In at least some instances, the approximating language may correspond to the precision of an instrument for measuring the value, or the precision of the methods or machines for constructing or manufacturing the components and systems. In at least some instances, the approximating language may correspond to the precision of an instrument for measuring the value, or the precision of the methods or machines for constructing or manufacturing the components and systems. For example, the approximating language may refer to being within a 1, 2, 4, 5, 10, 15, or 20 percent margin in either individual values, range(s) of values and endpoints defining range(s) of values. Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Additionally, as used herein, a “controller” can include a component configured or adapted to provide instruction, control, operation, or any form of communication for operable components to effect the operation thereof. A controller can include any known processor, microcontroller, or logic device, including, but not limited to: field programmable gate arrays (FPGA), an application specific integrated circuit (ASIC), a full authority digital engine control (FADEC), a proportional controller (P), a proportional integral controller (PI), a proportional derivative controller (PD), a proportional integral derivative controller (PID controller), proportional resonant controller (PR), a hardware-accelerated logic controller (e.g. for encoding, decoding, transcoding, etc.), the like, or a combination thereof. Non-limiting examples of a controller can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a controller can also include a data storage component accessible by the processor, including memory, whether transient, volatile or non-transient, or non-volatile memory.

Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to effect a functional or operable outcome, as described herein. In another non-limiting example, a controller can be configured for comparing a first value with a second value, and operating and controlling operations of additional components based on the satisfying of that comparison. For example, when a sensed, measured, or provided value is compared with another value, including a stored or predetermined value, the satisfaction of that comparison can result in actions, functions, or operations controllable by the controller.

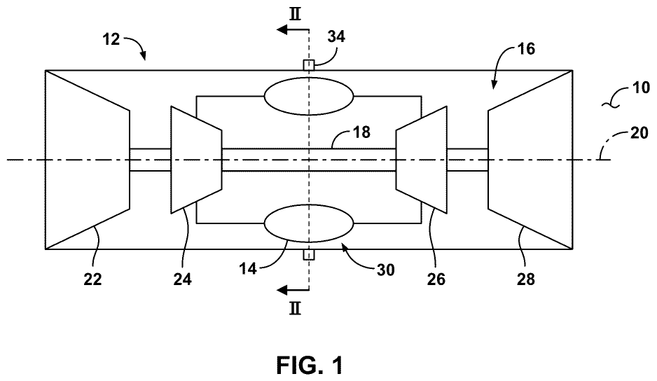

FIG. 1 is a schematic view of a turbine engine 10 (e.g., a gas turbine engine). As a non-limiting example, the turbine engine 10 can be used within an aircraft. The turbine engine 10 can include, at least, a compressor section 12, a combustion section 14, and a turbine section 16. A drive shaft 18 rotationally couples the compressor section 12 and turbine section 16, such that rotation of one affects the rotation of the other, and defines a rotational axis 20 for the turbine engine 10.

The compressor section 12 can include a low-pressure (LP) compressor 22, and a high-pressure (HP) compressor 24 serially fluidly coupled to one another. The turbine section 16 can include an HP turbine 26, and an LP turbine 28 serially fluidly coupled to one another. The drive shaft 18 can operatively couple the LP compressor 22, the HP compressor 24, the HP turbine 26, and the LP turbine 28 together. Alternatively, the drive shaft 18 can include an LP drive shaft and an HP drive shaft. The LP drive shaft can couple the LP compressor 22 to the LP turbine 28, and the HP drive shaft can couple the HP compressor 24 to the HP turbine 26. An LP spool can be defined as the combination of the LP compressor 22, the LP turbine 28, and the LP drive shaft such that the rotation of the LP turbine 28 can apply a driving force to the LP drive shaft, which in turn can rotate the LP compressor 22. An HP spool can be defined as the combination of the HP compressor 24, the HP turbine 26, and the HP drive shaft such that the rotation of the HP turbine 26 can apply a driving force to the HP drive shaft which in turn can rotate the HP compressor 24.

The compressor section 12 can include a plurality of axially spaced stages. Each stage includes a set of circumferentially-spaced rotating blades and a set of circumferentially-spaced stationary vanes. The compressor blades for a stage of the compressor section 12 can be mounted to a disk, which is mounted to the drive shaft 18. Each set of blades for a given stage can have its own disk. The vanes of the compressor section 12 can be mounted to a casing which can extend circumferentially about and enshroud one or more sections of the turbine engine 10. It will be appreciated that the representation of the compressor section 12 is merely schematic and that there can be any number of blades, vanes, and stages. Further, it is contemplated that there can be any number of other components within the compressor section 12.

Similar to the compressor section 12, the turbine section 16 can include a plurality of axially spaced stages, with each stage having a set of circumferentially-spaced, rotating blades and a set of circumferentially-spaced, stationary vanes. The turbine blades for a stage of the turbine section 16 can be mounted to a disk which is mounted to the drive shaft 18. Each set of blades for a given stage can have its own disk. The vanes of the turbine section 16 can be mounted to the casing in a circumferential manner. It is noted that there can be any number of blades, vanes, and turbine stages, as the illustrated turbine section 16 is merely a schematic representation. Further, it is contemplated that there can be any number of other components within the turbine section 16.

The combustion section 14 can be provided serially between the compressor section 12 and the turbine section 16. The combustion section 14 can be fluidly coupled to at least a portion of the compressor section 12 and the turbine section 16 such that the combustion section 14 at least partially fluidly couples the compressor section 12 to the turbine section 16. As a non-limiting example, the combustion section 14 can be fluidly coupled to the HP compressor 24 at an upstream end of the combustion section 14 and to the HP turbine 26 at a downstream end of the combustion section 14. The combustion section 14 can include a combustor 30 fluidly coupled to a fuel source 34.

During operation of the turbine engine 10, ambient or atmospheric air is drawn into the compressor section 12 via a fan upstream of the compressor section 12, where the air is compressed defining a pressurized air. The pressurized air can then flow into the combustion section 14 where the pressurized air is mixed with fuel and ignited, thereby generating combustion gases. Some work is extracted from these combustion gases by the HP turbine 26, which drives the HP compressor 24. The combustion gases are discharged from the HP turbine 26 into the LP turbine 28, which extracts additional work to drive the LP compressor 22, and the exhaust gas is ultimately discharged from the turbine engine 10 via an exhaust section downstream of the turbine section 16. The driving of the LP turbine 28 drives the LP spool to rotate the fan and the LP compressor 22. The pressurized airflow and the combustion gases can together define a working airflow that flows through the fan, compressor section 12, combustion section 14, and turbine section 16 of the turbine engine 10.

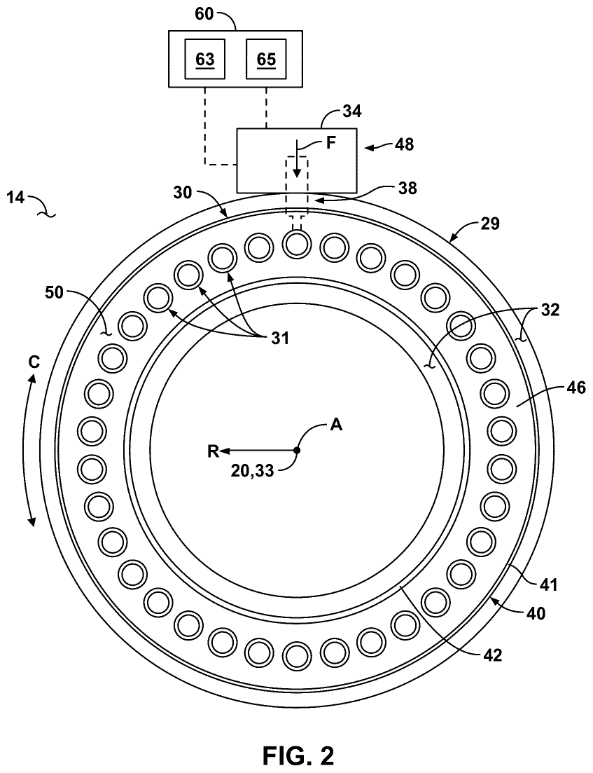

FIG. 2 depicts a cross-sectional view of the combustion section 14 along line II-II of FIG. 1. The combustion section 14 can include the combustor 30 with an annular arrangement of combustor cups 31 disposed around the centerline or rotational axis 20 of the turbine engine 10 (e.g., circumferentially spaced from each other in an annular configuration) (FIG. 1). The combustor cups 31 can, in some configurations, include or be configured as combustor cups, fuel cups, or nozzle cups. A fuel nozzle assembly 48 can be connected to each combustor cup 31. The combustor 30 can have a can, can-annular, or annular arrangement depending on the type of engine in which the combustor 30 is located. In a non-limiting example, the combustor 30 can have a combination arrangement located with a shroud or casing 29 of the turbine engine 10. The shroud or casing 29 can enshroud or cover at least a portion of the combustion section 14.

The combustor 30 can be at least partially defined by a combustor liner 40. In some examples, the combustor liner 40 can include an outer liner 41 and an inner liner 42 concentric with respect to each other and arranged in an annular fashion about the engine centerline or rotational axis 20. In some examples, the combustor liner 40 can have an annular structure about the combustor 30. In some examples, the combustor liner 40 can include multiple segments or portions collectively forming the combustor liner 40. In some examples, the combustor liner 40 can include the outer liner 41 radially spaced from the inner liner 42. In some examples, the combustor liner 40 can include a single liner.

The combustor liner 40 can at least partially define a combustion chamber 50 arranged annularly about the rotational axis 20. For example, a dome wall 46 may be substantially perpendicular to the rotational axis 20 and can cooperate with the outer liner 41, the inner liner 42, or both, to at least partially define the combustion chamber 50. A compressed air passage 32 can be defined at least in part by both the combustor liner 40 and the casing 29.

The combustor 30 can include or be fluidly coupled to the fuel source 34 (e.g., an external fuel manifold). The fuel nozzle assembly 48 fluidly couples the fuel source 34 with the combustor cups 31 and the combustion chamber 50. The fuel nozzle assembly 48 can include a fuel nozzle body 38 and can be coupled to the dome wall 46. A fuel F can include any suitable fuel, including gaseous fuel, such as hydrogen fuel, in non-limiting examples, which can include 100% H₂ (e.g., without a diluent). For example, the fuel nozzle assembly 48 can be a gaseous fuel nozzle assembly, such as a gaseous hydrogen fuel nozzle assembly. Additionally or alternatively, the fuel source 34 can be a gaseous hydrogen fuel source. In some examples, hydrogen can be stored as a liquid and provided to or by the fuel source 34 as hydrogen gas. The combustor cups 31 can be spaced along the dome wall 46 in a circumferentially spaced configuration. The combustor cups 31 can be disposed at a radial distance from the rotational axis 20 that is greater than a radial distance of the inner liner 42 and less than a radial distance of the outer liner 41. A controller 60 can be connected to and at least partially control operation of the fuel source 34, the fuel nozzle assembly 48, or both. The controller 60 can include a processor 63 and a memory 65. A centerline 33 of the combustion section 14 can be concentric with the rotational axis 20. The centerline 33 can define a radial direction R, an axial direction A, and a circumferential direction C.

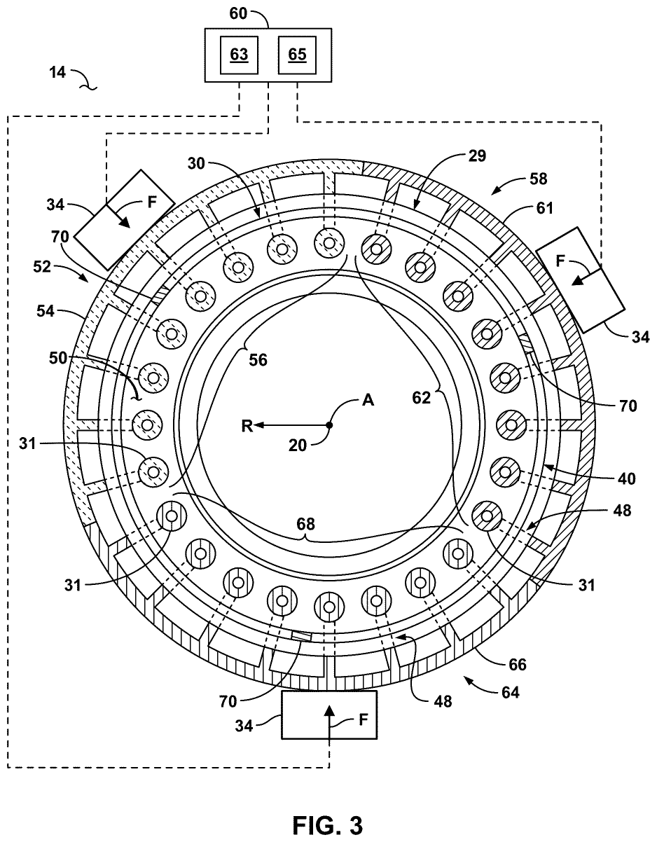

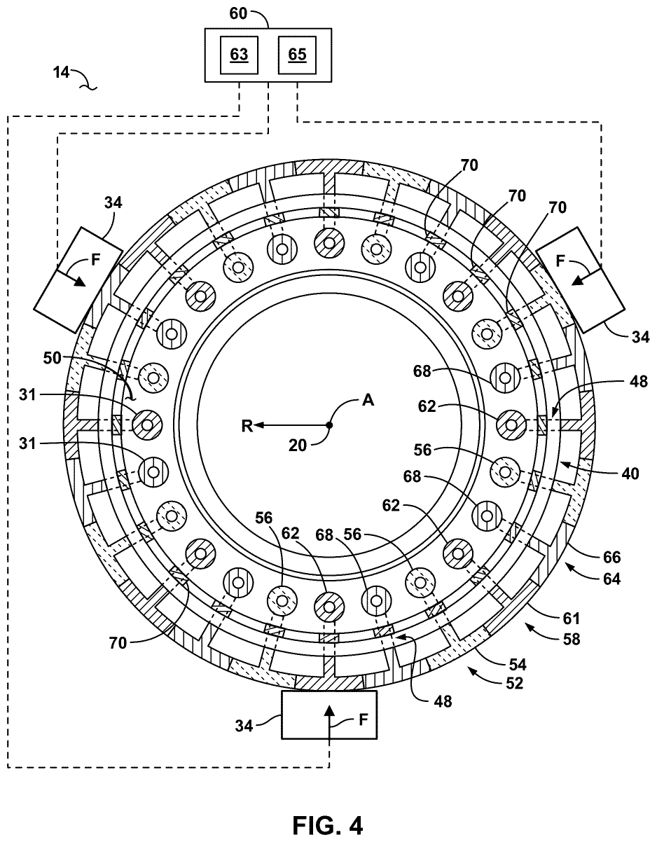

Referring to FIGS. 3 and 4, in a non-limiting example, the combustion section 14 can include the plurality of combustor cups 31, a first fuel circuit 52, a second fuel circuit 58, and a third fuel circuit 64. The combustor cups 31 can include a first set of combustor cups 56, a second set of combustor cups 62, and a third set of combustor cups 68. The first fuel circuit 52 can include a first manifold 54 fluidly coupled with the fuel source 34 and the first set of combustor cups 56. The second fuel circuit 58 can include a second manifold 61 fluidly coupled with the fuel source 34 and the second set of combustor cups 62. The third fuel circuit 64 can include a third manifold 66 fluidly coupled with the fuel source 34 and the third set of combustor cups 68. The first manifold 54, the second manifold 61, and the third manifold 66 are disposed partially outside the casing 29, and extend through the casing 29 to fluidly couple with the first set of combustor cups 56, the second set of combustor cups 62, and the third set of combustor cups 68, respectively. With examples, the combustion section 14 can include other numbers of manifolds, such as at least two or at least four and less than or equal to the number of the combustor cups 31. The fuel source 34 is illustrated with three sections, but the fuel source 34 can be provided as a single component fluidly coupled with each of the first fuel circuit 52, the second fuel circuit 58, and the third fuel circuit 64. The first fuel circuit 52, the second fuel circuit 58, and the third fuel circuit 64 can be independent of each other such that fuel F can be provided to one without providing fuel F to the others.

The combustion section 14 can include one or more ignitors 70 to light the plurality of combustor cups 31. For example, each of the first fuel circuit 52, the second fuel circuit 58, and the third fuel circuit 64 can include at least one ignitor 70.

The controller 60 is illustrated with the processor 63 and the memory 65, and can be connected to and at least partially control operation of the fuel source 34, the fuel nozzle assemblies 48, the first fuel circuit 52, the second fuel circuit 58, the third fuel circuit 64, or a combination thereof. For example, the controller 60 can be configured to selectively and separately provide fuel F from the fuel source 34 to at least one of (i) the first set of combustor cups 56 via the first fuel circuit 52, (ii) the second set of combustor cups 62 via the second fuel circuit 58, or (iii) the third set of combustor cups 68 via the third fuel circuit 64. Being configured to selectively and separately provide fuel F to different groups of the combustor cups 31 can allow for more accurate and efficient control of the flow of fuel F, and can facilitate modifying fuel flow according to engine conditions.

The controller 60 can be configured to detect one or more engine conditions. In a non-limiting example, the engine condition can include an engine core speed, an engine core acceleration, a total fuel flow, a time delay, or combinations thereof. The controller 60 can selectively provide fuel F from the fuel source 34 to at least one of the first set of combustor cups 56, the second set of combustor cups 62, or the third set of combustor cups 68 according to the one or more engine conditions, in order to facilitate lightoff or relighting of the combustion section 14. For example, the controller 60 is configured to control the flow of fuel F to at least one of the first fuel circuit 52, the second fuel circuit 58, or the third fuel circuit 64 such that at least one engine condition detected by the controller 60 (e.g., total fuel flow, core speed) is within one or more predetermined thresholds. In a non-limiting example, the one or more predetermined thresholds include a compressor stall threshold for the total fuel flow, a blowout threshold for combustor cup fuel flow, and a lightoff threshold for combustor cup fuel flow.

The compressor stall threshold can include a maximum fuel amount (e.g., the sum of fuel flow to the combustion chamber 50 from all of the combustor cups 31 to avoid compressor stall. The blowout threshold can include a minimum fuel amount for each of the combustor cups 31 to maintain a flame (e.g., without the flame blowing out). The lightoff threshold can include a minimum fuel amount for each of the combustor cups 31 to initially generate a sustainable flame.

In examples in which the one or more engine conditions include a time delay (e.g., a delay since first attempting lightoff or relight), the controller 60 can operate at least one of the first, second, or third fuel circuits 52, 58, 64 based on a predetermined time delay. For example, the controller 60 can initially operate only the first fuel circuit 52 to provide fuel F to the combustion chamber 50, and, after the time delay, operate one or both of the second fuel circuit 58 or the third fuel circuit 64 to also provide fuel F to the combustion chamber 50. The time delay can, for example, correspond to an expected amount of time for the core speed to reach a minimum speed threshold.

Referring to FIG. 3, in a non-limiting example, the first set of combustor cups 56, the second set of combustor cups 62, and the third set of combustor cups 68 are arranged in an adjacent pattern, with all of the first set of combustor cups 56 directly adjacent to each other (e.g., without combustor cups from the second or third sets of combustor cups 62, 68 disposed therebetween), all of the second set of combustor cups 62 directly adjacent to each other, and all of the third set of combustor cups 68 directly adjacent to each other. For example, with the first, second, and third sets of combustor cups 56, 62, 68 each including three of the combustor cups 31 of nine total combustor cups, the combustor cups 31 can be arranged in a first-first-first-second-second-second-third-third-third configuration arranged about the centerline or rotational axis 20 (e.g., circumferentially spaced from each other in an annular configuration). In a non-limiting example, the first, second, and third sets of combustor cups 56, 62, 68 can be arranged where subsets of the first, second, and third sets of combustor cups 56, 62, 68 are in an alternating configuration. For example, the first, second, and third sets of combustor cups 56, 62, 68 each include six combustor cups 31 of 18 total combustor cups, and each subset of the first, second, and third sets of combustor cups 56, 62, 68 can include three combustor cups 31. The combustor cups 31 can then be arranged in a first-first-first-second-second-second-third-third-third-first-first-first-second-second-second-third-third-third configuration arranged about the centerline or rotational axis 20 (e.g., circumferentially spaced from each other in an annular configuration). The combustion section 14 can include an ignitor of the one or more ignitors 70 for each of the plurality of combustor cups 31, an ignitor of the one or more ignitors 70 for each set of combustor cups 56, 62, 68, or an ignitor of the one or more ignitors for each subset of combustor cups.

Referring to FIG. 4, in a non-limiting example, the combustor cups 31 of the first set of combustor cups 56, the second set of combustor cups 62, and the third set of combustor cups 68 can be disposed in an alternating configuration, such as first-second-third-first-second-third, and disposed around the centerline or rotational axis 20 (e.g., circumferentially spaced from each other in an annular configuration). For example, each combustor cup of the first set of combustor cups 56 can be directly adjacent with a combustor cup of the second set of combustor cups 62 and a combustor cup of the third set of combustor cups 68.

With such an alternating configuration, the combustion section 14 can include an ignitor of the one or more ignitors 70 for each combustor cup of the first set of combustor cups 56, each combustor cup of the second set of combustor cups 62, and each combustor cup of the third set of combustor cups 68. For example, each combustor cup of the first set combustor cups 56 can be spaced (e.g., in both circumferential directions) from the next adjacent combustor cup of the first set of combustor cup 56 by at least one of the combustor cups of the second set of combustor cups 62 and at least one of the combustor cups of the third set of combustor cups 68, and such spacing may limit or prevent flame propagation between adjacent first combustor cups 56. Providing an ignitor of the one or more ignitors 70 for each of the combustor cups of the first set of combustor cups 56 can ensure ignition of fuel F in each combustor cup of the first set of combustor cups 56. In another non-limiting example, each combustor cup of the first set of combustor cups 56 includes the one or more ignitors 70. The ignited flows from the set of first combustor cups 56 can propagate to ignite the fuel flow in each combustor cup of the second set of combustor cups 62 and each combustor cup of the third set of combustor cups 68.

In the non-limiting examples shown in FIGS. 3 and 4, the combustion section 14 includes three fuel circuits. However, the combustion section 14 can, for example, include other numbers of fuel circuits, such as at least two or at least four and less than or equal to the number of the combustor cups 31.

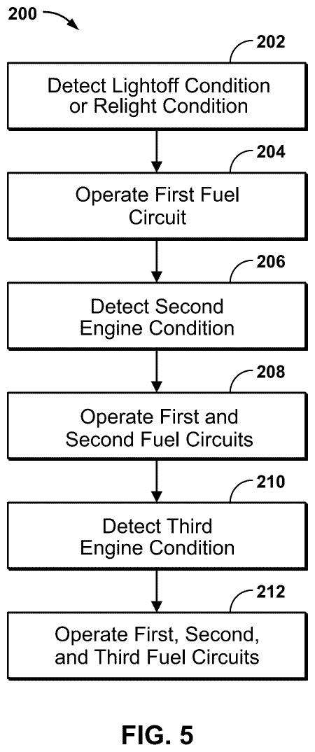

FIG. 5 illustrates a method 200 of operating a turbine engine that can be utilized in connection with the turbine engine 10 of FIG. 1 and the combustion sections 14 illustrated in FIGS. 2-4. At block 202, the controller 60 can detect an engine lightoff condition or an engine relight condition, such as via one or more sensors. In response to the controller 60 detecting the lightoff or relight condition, the controller 60, at block 204, can operate the first fuel circuit 52 to initiate or conduct lightoff or relight of the turbine engine 10. For example, the controller 60 can selectively supply fuel F to the first set of combustor cups 56 to initiate or conduct lightoff or relight of the turbine engine 10, such as without supplying fuel F to the second set of combustor cups 62 or the third set of combustor cups 68. In a non-limiting example, block 204 can include activating the one or more ignitors 70 for each combustor cup of the first set of combustor cups 56 to separately ignite fuel F in each combustor cup of the first set of combustor cups 56. Such separate ignition may be desirable for arrangements with the combustor cups 31 disposed in alternating configurations, such as the alternating configuration illustrated in FIG. 4. The separate ignition can facilitate timely ignition of each combustor cup of the first set of combustor cups 56. In other combustor cup configurations, such as in FIG. 3, ignition of one combustor cup in the first set of combustor cups 56 can ignite fuel F in adjacent combustor cups in the first set of combustor cups 56.

Block 204 can include providing fuel F to the first fuel circuit 52 such that a total fuel output into the combustion chamber 50 is below a first fuel threshold, such as the compressor stall threshold. For example, the controller 60 can control the fuel source 34, the first fuel circuit 52, or both, to provide an amount of fuel F from the first set of combustor cups 56 to the combustion chamber 50 that is less than the compressor stall threshold. In a non-limiting example, the compressor stall threshold is in a range that is above the lightoff threshold of the first fuel circuit 52, but below the lightoff threshold for the first and second fuel circuits 52, 58 combined.

Additionally, providing fuel F in block 204 can include providing fuel F to the first fuel circuit 52 such that a combustion cup fuel output of each the first set of combustion cups 56 is above a second fuel threshold. In a non-limiting example, the second fuel threshold can be a lightoff threshold. The lightoff threshold can include a minimum fuel flow to a particular combustor cup of the combustor cups 31 that allows for lighting (e.g., generating a sustainable flame). The lightoff threshold for fuel circuits after the first fuel circuit 52, such as the second and third fuel circuits 58, 64, can be lower than that of the first fuel circuit 52 due to the presence of an existing flame within the combustion chamber 50.

In a non-limiting example, operating the first fuel circuit 52 (block 204) can include separately igniting fuel in each combustor cup of the first set of combustor cups 56 when the combustor cups 31 are in an alternating configuration such as in FIG. 4. However, fuel F can also be separately ignited in other combustor cup configurations.

At block 206, the controller 60 can detect the second engine condition. In a non-limiting example, the second engine condition corresponds to a transient condition after lightoff or relight and prior to reaching idle. In response to detecting the second engine condition, the controller 60, at block 208, can operate the first fuel circuit 52 and the second fuel circuit 58 (e.g., continue operating the first fuel circuit 52 and start operating the second fuel circuit 58). Operating the first fuel circuit 52 and the second fuel circuit 58 (block 208) can include supplying fuel F to the first fuel circuit 52 and the second fuel circuit 58 such that the total fuel output remains below the compressor stall threshold. For example, the controller 60 is configured to control the first fuel circuit 52 and the second fuel circuit 58 to operate the turbine engine 10 in the transient condition while maintaining a total fuel flow below the compressor stall threshold. The compressor stall threshold can increase as the turbine engine 10 transitions from the lightoff or relight condition to the transient condition. Further, fuel F is supplied to the first fuel circuit 52 and the second fuel circuit 58 such that the combustion cup fuel output of the first set of combustion cups 56 and the second set of combustion cups 62 are above the blowout threshold. In a non-limiting example, the blowout threshold is lower than the second fuel threshold (e.g., the lightoff threshold).

At block 210, the controller 60 can detect a third engine condition. In a non-limiting example, the third engine condition corresponds to the turbine engine 10 reaching a fuel flow of, for example, 60-80% of an idle state. At block 212, the controller 60 operates the first fuel circuit 52, the second fuel circuit 58, and the third fuel circuit 64 in response to detecting the third engine condition. Fuel F is supplied to all of the combustor cups 31 such that the combustion cup fuel output of the first set of combustor cups 56, the second set of combustor cups 62, and the third set of combustor cups 68 is above a blowout threshold.

While the method 200 is described in connection with fuel thresholds, the method 200 can, additionally or alternatively, be conducted with engine core speed thresholds, engine core acceleration thresholds, total fuel flow threshold, a time delay, or combinations thereof.

To the extent not already described, the different features and structures of the various embodiments can be used in combination, or in substitution with each other as desired. That one feature is not illustrated in all of the embodiments is not meant to be construed that it cannot be so illustrated but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A gas turbine engine, comprising: a compressor section, a combustion section, and a turbine section in serial flow arrangement, with the combustion section comprising: a combustor liner at least partially defining a combustion chamber; a plurality of combustor cups fluidly coupled with the combustion chamber and including a first set of combustor cups and a second set of combustor cups; a first fuel circuit comprising a first manifold fluidly coupled with a fuel source and the first set of combustor cups; and a second fuel circuit comprising a second manifold fluidly coupled to the second set of combustor cups; and a controller configured to detect an engine condition, and to control the first fuel circuit and the second fuel circuit to selectively provide fuel from the fuel source to at least one of the first set of combustor cups or the second set of combustor cups according to the engine condition to facilitate lightoff or relighting of the combustion section.

The gas turbine engine of any preceding clause, wherein the controller is configured to control the first fuel circuit and the second fuel circuit to facilitate the lightoff or relighting while maintaining a total fuel flow below a compressor stall threshold.

The gas turbine engine of any preceding clause, wherein the fuel comprises hydrogen.

The gas turbine engine of any preceding clause, wherein the combustor cups of the first set of combustor cups and the second set of combustor cups are disposed in an alternating configuration.

The gas turbine engine of any preceding clause, wherein the plurality of combustor cups includes a third set of combustor cups, wherein the combustion section further comprises a third fuel circuit including a third manifold fluidly coupled with the fuel source and the third set of combustor cups.

The gas turbine engine of any preceding clause, wherein the combustor cups of the third set of combustor cups is disposed in an alternating configuration with the combustor cups of the first set of combustor cups and the second set of combustor cups.

The gas turbine engine of any preceding clause, wherein subsets of the first set of combustor cups, subsets of the second set of combustor cups, and subsets of the third set of combustor cups are disposed in an alternating configuration.

The gas turbine engine of any preceding clause, wherein the subsets of the first set of combustor cups comprise two subsets of combustor cups each comprising three combustor cups.

The gas turbine engine of any preceding clause, wherein the subsets of the second set of combustor cups comprise two subsets of combustor cups each comprising three combustor cups.

The gas turbine engine of any preceding clause, wherein the subsets of the third set of combustor cups comprise two subsets of combustor cups each comprising three combustor cups.

The gas turbine engine of any preceding clause, wherein the first set of combustor cups, the second set of combustor cups, and the third set of combustor cups are arranged in an adjacent pattern.

The gas turbine engine of any preceding clause, wherein each of the first fuel circuit, the second fuel circuit, and the third fuel circuit includes at least one ignitor.

The gas turbine engine of any preceding clause, wherein the combustion section includes an ignitor for each combustor cup of the plurality of combustor cups.

The gas turbine engine of any preceding clause, wherein the combustion section includes an ignitor for each subset of combustor cups.

The gas turbine engine of any preceding clause, wherein the controller is configured to control fuel flow to at least one of the first fuel circuit, the second fuel circuit, or the third fuel circuit such at least one of a total fuel flow or a combustor cup fuel flow is within one or more predetermined thresholds.

The gas turbine engine of any preceding clause, wherein the engine condition is a relight or lightoff condition.

The gas turbine engine of any preceding clause, wherein the one or more predetermined thresholds includes a compressor stall threshold, a blowout threshold, and a lightoff threshold.

The gas turbine engine of any preceding clause, wherein the engine condition includes at least one of a time delay, an engine core speed, an engine core acceleration, or a total fuel flow.

A method of operating a gas turbine engine having a combustion section including a fuel source, a first set of combustor cups, a first fuel circuit, a second set of combustor cups, and a second fuel circuit, the method comprising: detecting an engine lightoff condition or an engine relight condition; and operating the first fuel circuit to conduct lightoff or relight of the gas turbine engine such that a total fuel output is below a first fuel threshold and such that a combustor cup fuel output of the first fuel circuit is above a second fuel threshold.

The method of any preceding clause, wherein the operating the first fuel circuit comprises separately igniting fuel in each combustor cup of the first set of combustor cups.

The method of any preceding clause, wherein the first fuel circuit includes a first manifold fluidly coupled with the fuel source and the first set of combustor cups; wherein the second fuel circuit includes a second manifold fluidly coupled with the fuel source and the second set of combustor cups; and wherein operating the first fuel circuit includes providing fuel from the fuel source to the first set of combustor cups via the first manifold.

The method of any preceding clause, further comprising: detecting a second engine condition; and operating the first fuel circuit and the second fuel circuit in response to detecting the second engine condition such that the total fuel output is below a compressor stall threshold and the combustor cup fuel output of the first fuel circuit and the second fuel circuit is above a blowout threshold.

The method of any preceding clause, wherein the combustion section includes a third set of combustor cups and a third fuel circuit including a third manifold fluidly coupled with the fuel source and the third set of combustor cups; and wherein the method further comprises: detecting a third engine condition; and operating the first fuel circuit, the second fuel circuit, and the third fuel circuit such that the combustor cup fuel output of the first fuel circuit, the second fuel circuit, and the third fuel circuit is above the blowout threshold and fuel is provided to all combustor cups of the combustion section.

The method of any preceding clause, wherein the second engine condition corresponds to a transient condition after lightoff or relight.

The method of any preceding clause, wherein the third engine condition corresponds to a fuel flow of 60% to 80% of an idle state.

The method of any preceding clause, wherein the blowout threshold is lower than the second fuel threshold.

The method of any preceding clause, wherein the operating the first fuel circuit includes providing hydrogen fuel to the first fuel circuit.

1. A gas turbine engine, comprising:
a compressor section, a combustion section, and a turbine section in serial flow arrangement, with the combustion section comprising:
a combustor liner at least partially defining a combustion chamber;
a plurality of combustor cups fluidly coupled with the combustion chamber and including a first set of combustor cups and a second set of combustor cups;
a first fuel circuit comprising a first manifold fluidly coupled with a fuel source and the first set of combustor cups;
a second fuel circuit comprising a second manifold fluidly coupled to the second set of combustor cups; and
a controller configured to detect an engine condition, and to control the first fuel circuit and the second fuel circuit to selectively provide fuel from the fuel source to at least one of the first set of combustor cups or the second set of combustor cups according to the engine condition to facilitate lightoff or relighting of the combustion section,
wherein the fuel comprises diatomic hydrogen without diluent.

2. The gas turbine engine of claim 1, wherein the controller is configured to control the first fuel circuit and the second fuel circuit to facilitate the lightoff or relighting while maintaining a total fuel flow below a compressor stall threshold.

3. (canceled)

4. The gas turbine engine of claim 1, wherein the combustor cups in the first set of combustor cups and the second set of combustor cups are disposed in an alternating configuration.

5. The gas turbine engine of claim 1, wherein the plurality of combustor cups includes a third set of combustor cups, wherein the combustion section further comprises a third fuel circuit including a third manifold fluidly coupled with the fuel source and the third set of combustor cups.

6. The gas turbine engine of claim 5, wherein the combustor cups of the third set of combustor cups are disposed in an alternating configuration with each combustor cup of the first set of combustor cups and the second set of combustor cups.

7. The gas turbine engine of claim 5, wherein each of the first fuel circuit, the second fuel circuit, and the third fuel circuit includes at least one ignitor.

8. The gas turbine engine of claim 5, wherein the controller is configured to control fuel flow to at least one of the first fuel circuit, the second fuel circuit, or the third fuel circuit such that at least one of a total fuel flow or a combustor cup fuel flow is within one or more predetermined thresholds.

9. The gas turbine engine of claim 8, wherein the engine condition is a relight or a lightoff condition.

10. The gas turbine engine of claim 8, wherein the one or more predetermined thresholds includes a compressor stall threshold, a blowout threshold, and a lightoff threshold.

11. The gas turbine engine of claim 5, wherein the engine condition includes at least one of a time delay, an engine core speed, an engine core acceleration, or a total fuel flow.

12. A method of operating a gas turbine engine having a combustion section including a fuel source, a first set of combustor cups, a first fuel circuit, a second set of combustor cups, and a second fuel circuit, the method comprising:
detecting an engine lightoff condition or an engine relight condition;
operating the first fuel circuit to conduct lightoff or relight of the gas turbine engine such that a total fuel output is below a first fuel threshold and such that a combustor cup fuel output of the first fuel circuit is above a second fuel threshold; and
after a predetermined time delay, operating the second fuel circuit independent of the first fuel circuit such that the first fuel circuit provides fuel to the first set of combustor cups and the second fuel circuit is maintained in a fuel-inactive state with respect to the second set of combustor cups.

13. The method of claim 12, wherein the operating the first fuel circuit comprises separately igniting fuel in each combustor cup of the first set of combustor cups.

14. The method of claim 12, wherein the first fuel circuit includes a first manifold fluidly coupled with the fuel source and the first set of combustor cups;
wherein the second fuel circuit includes a second manifold fluidly coupled with the fuel source and the second set of combustor cups; and
wherein operating the first fuel circuit includes providing fuel from the fuel source to the first set of combustor cups via the first manifold.

15. The method of claim 12, further comprising:
detecting a second engine condition; and
operating the first fuel circuit and the second fuel circuit in response to detecting the second engine condition such that the total fuel output is below a compressor stall threshold and the combustor cup fuel output of the first fuel circuit and the second fuel circuit is above a blowout threshold.

16. The method of claim 15, wherein the combustion section includes a third set of combustor cups and a third fuel circuit including a third manifold fluidly coupled with the fuel source and the third set of combustor cups; and
wherein the method further comprises:
detecting a third engine condition; and
operating the first fuel circuit, the second fuel circuit, and the third fuel circuit such that the combustor cup fuel output of the first fuel circuit, the second fuel circuit, and the third fuel circuit is above the blowout threshold and fuel is provided to all combustor cups of the combustion section.

17. The method of claim 16, wherein the second engine condition corresponds to a transient condition after lightoff or relight.

18. The method of claim 16, wherein the third engine condition corresponds to a fuel flow of 60% to 80% of an idle state.

19. The method of claim 16, wherein the blowout threshold is lower than the second fuel threshold.

20. The method of claim 12, wherein the operating the first fuel circuit includes providing hydrogen fuel to the first fuel circuit.

21. The gas turbine engine of claim 1, wherein the first set of combustor cups are circumferentially adjacent to one another about the combustion chamber and the second set of combustor cups are circumferentially adjacent to one another about the combustion chamber.
